(19) United States
(12) Patent Application Publication
(10) Pub. No.: US 2019/0360884 A1
(43) Pub. Date: Nov. 28, 2019

(54) Fuel Pressure Testing Accessory

(71) Applicant: Charles Newton, Newark Valley, NY (US)

(72) Inventor: Charles Newton, Newark Valley, NY (US)

(21) Appl. No.: 15/987,224

(22) Filed: May 23, 2018

(51) Int. Cl. G01L 19/00; F02M 55/00; F16L 41/00; F02M 65/00

(52) U.S. Cl. CPC G01L 19/003; F02M 55/005; F02M 55/02; F02M 65/003; F16L 41/008

(57) ABSTRACT

An adaptor for connecting a pressure gauge to a fuel conduit not provided with a connection port. The adaptor may comprise a tube including a schrader valve, threads for engaging the pressure gauge, a standard automotive fuel conduit, and standard automotive connectors connecting the tube to the fuel conduit, and the fuel conduit to a pressurized fuel conduit of a vehicle. The adaptor may be provided as a kit including interchangeable tubes, conduits, and connectors, to accommodate vehicle fuel conduits of different configurations and sizes.

### FIELD OF THE DISCLOSURE

The present disclosure relates to testing fuel pressure, and more particularly, to an adaptor for adapting a pressure gauge to a pressurized automotive fuel conduit.

### BACKGROUND

Contemporary motor vehicles in the U.S. are mostly fuel injected. Fuel injection requires delivery of fuel at greater than nominal pressures to operate satisfactorily. When an engine of a motor vehicle does not start or run, one of the diagnostic procedures may be to test sufficiency of fuel delivery pressure. Some vehicles are provided with a port enabling ready attachment of a pressure gauge. Other vehicles are not so equipped.

A technician wishing to test fuel pressure is left to his or her own devices in the latter case. It is not difficult to identify and open a pressurized fuel conduit, but successfully and safely attaching a pressure gauge is another matter. There exists a need for adaptors capable of connecting to automotive fuel systems not originally provided with apparatus enabling ready attachment of fuel pressure gauges.

### SUMMARY

The disclosed concepts address the above stated situation by providing, in one aspect of the disclosure, an adaptor for adapting a fuel pressure gauge to a pressurized automotive fuel conduit, and in other aspects of the disclosure, a kit providing adaptors presenting a choice of connectors. Although fuel systems and conduits may differ, among most automobiles and light trucks, there is a very limited number of fuel conduit sizes which must be accommodated to assure proper fit and successful connection. Therefore, the kit contemplates satisfying the overwhelming majority if not all of the types of fuel conduits which may have to be interrupted for installation of a fuel pressure gauge.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a side view of an adaptor for connecting a pressure gauge to a pressurized vehicular fuel conduit, according to at least one aspect of the disclosure;

FIG. 2 is an exaggerated environmental side view illustrating an exemplary vehicle, an adaptor according to at least one aspect of the present disclosure, and a representative fuel pressure gauge;

FIG. 3 is an exploded side view of a kit providing components for assembling a variety of adaptors such as the adaptor of FIG. 1, according to aspects of the disclosure; and

FIG. 4 is an enlarged side cross sectional detail view, taken along line 4-4 of FIG. 1.

### DETAILED DESCRIPTION

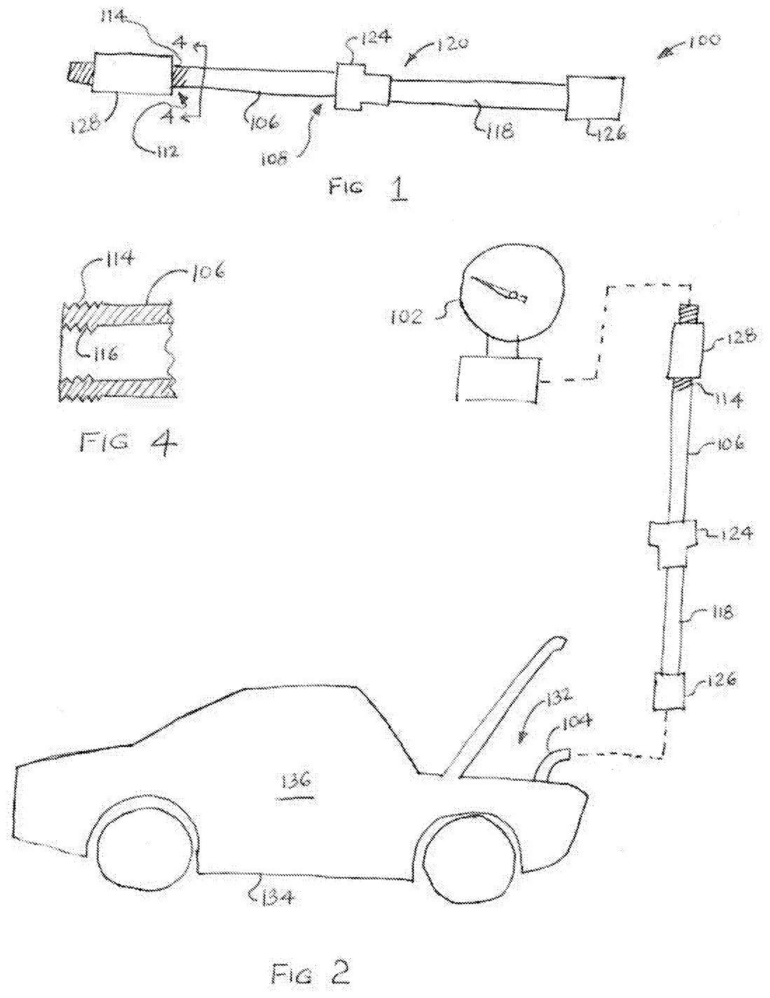

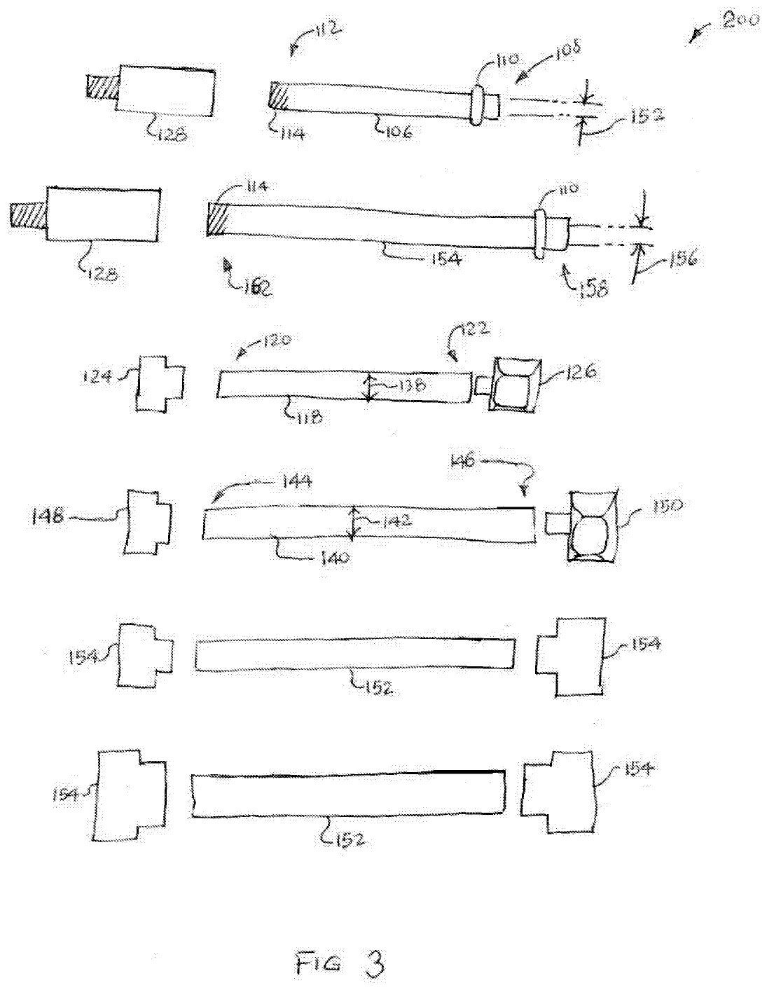

Referring first to FIG. 1, according to at least one aspect of the disclosure, there is shown an adaptor 100 for connecting a pressure gauge 102 (FIG. 2) to a pressurized vehicular fuel conduit 104 (FIG. 2). Adaptor 100 comprises a valve tube 106 for connection to pressure gauge 102. Valve tube 106 may include a proximal end 108 having an outwardly projecting flare 110 (FIG. 3) and a distal end (see also FIG. 3) having an external thread 114 and an internal thread 116 (see FIG. 4), and a standard automotive fuel conduit 118 including a distal end 120 facing valve tube 106 and a proximal end 122.

Adaptor 100 may comprise a first standard automotive fuel connector 124 between valve tube 106 and standard automotive fuel conduit 118 and a second standard automotive fuel connector 126 connected to proximal end 122 of standard automotive conduit 118, and a self-closing valve 128 threaded to one of external thread 114 and internal thread 116 of valve tube 106. Self-closing valve 128 may comprise a connection thread 130. Thus adaptor 100 may be installed on pressurized vehicular fuel conduit 104 using second standard automotive fuel connector 126; pressure gauge 102 may be threaded to self-closing valve 128; pressure gauge 102, when adaptor 100 is installed on pressurized vehicular fuel conduit 118 at one end of adaptor 100 and to pressure gauge 102 at an opposed end of adaptor 100, will indicate fuel pressure within pressurized vehicular fuel conduit 104, and self-closing valve 102 prevents external fluids (not shown) from entering pressurized vehicular fuel conduit 104. Therefore, adaptor 100 is readily fabricated from existing commercial components, enables ready connection to pressure gauge 102, and protects the fuel system (not separately shown) from ingress of foreign fluids which might be introduced when the original vehicle fuel system is interrupted to install adaptor 100 and test fuel pressure.

Valve tube 106 is so called because it is associated with self-closing valve 128, the latter so called because it closes in response to pressure within pressurized vehicular fuel conduit 104. Valve tube 106 may comprise majority aluminum constituency, such as aluminum and its alloys. This is a practical choice since aluminum (alloy) tubing is widely available, and is easily threaded. Self-closing valve 128 may be a Schrader valve for example. Self-closing valve 128 may be located at proximal end 108 of valve tube 106, or in the middle area of valve tube 106 if desired.

Pressurized vehicular fuel conduit 104 is shown only representatively as projecting from engine compartment 132. A pressurized vehicular fuel conduit 104 may be beneath chassis or body 134, near a fuel tank (not shown), or in any other location on vehicle 136.

Standard automotive fuel conduit 118, and first and second standard automotive fuel connectors are “standard” in that the automotive industry has standardized on certain configurations, thread characteristics, and the like, and are widely commercially available as individual components readily installed into vehicular fuel systems.

Adaptor 100 may be assembled in anticipation of use with a particular model vehicular fuel conduit 104, and maintained and used as a tool for repeated usages. Alternatively, adaptor 100 may be assembled from a collection of components offering a wide variety of size and configuration choices. This may be accomplished by providing an adaptor kit 200.

Referring also to FIG. 3, adaptor kit 200 for connecting pressure gauge 102 to pressurized vehicular fuel conduit 104 may comprise valve tube 106 for connection to pressure gauge 102 (FIG. 2), valve tube 106 including proximal end 108 having outwardly projecting flare 110 (FIG. 3), threaded distal end 112, and self-closing valve 128 in series within valve tube 106. Adaptor kit 200 may comprise first standard automotive fuel conduit 118 having a first diameter 138, first standard automotive fuel conduit 118 including distal end 120 for connection to valve tube 106 and proximal end 122 for connection to pressurized vehicular fuel conduit 104, first standard automotive fuel connector 124 connectable by frictional engagement of flare 110 to valve tube 106 and connectable to first standard automotive fuel conduit 118, and second standard automotive fuel connector 126 connectable to proximal end 122 of first standard automotive fuel conduit 118 and to pressurized vehicular fuel conduit 104.

Adaptor kit 200 may further comprise a second standard automotive fuel conduit 140 having a second diameter 142 different from first diameter 138, second standard automotive fuel conduit 140 including a distal end 144 for connection to valve tube 106 and a proximal end 146 for connection to pressurized vehicular fuel conduit 104, and a third standard automotive fuel connector 148 connectable by frictional engagement of flare 110 to valve tube 106, and connectable to second standard automotive fuel conduit 140, and a fourth standard automotive fuel connector 150 connectable to proximal end of second standard automotive fuel conduit 140 and to pressurized vehicular fuel conduit 104. Adaptor kit 200 may further comprise self-closing valve 128 in series with valve tube 106. Hence, a choice of adaptors (e.g., adaptor 100) is provided for installing on pressurized vehicular fuel conduit 104 to enable successful installation when a size of pressurized vehicular fuel conduit 140 is not known. Also, pressure gauge 102 may be threaded to valve tube 106, pressure gauge 102, when the adaptor has been assembled from components of adaptor kit 200 and is installed on pressurized vehicular fuel conduit 104 at one end of the adaptor and to pressure gauge 102 at an opposed end of the adaptor, will indicate fuel pressure within pressurized vehicular fuel conduit 104, and self-closing valve 128 prevents external fluids from entering pressurized vehicular fuel conduit 104.

As employed herein, “in series” will be understood to encompass locations at either end or in the middle area of the respective valve tube (e.g., valve tube 106).

As with assembled adaptor 100, in an adaptor assembled from adaptor kit 200, threaded distal ends (e.g., 112) of valve tube 106 may comprise both internal threads and external threads (e.g., 114, 116, as seen in FIG. 3).

Additionally, in adaptor kit 200, valve tube 106 may be a first valve tube having a first diameter 152, and adaptor kit 200 may further comprise a second valve tube 154 for connection to pressure gauge 102, second valve tube 154 having a second diameter 156 different from first diameter 152, a proximal end 158 having an outwardly projecting flare 160, and a distal end 162 connectable to at least one of first standard automotive fuel conduit 118 and second standard automotive fuel conduit 140.

Adaptor kit 200 may include any number of additional standard automotive fuel conduits 152, standard automotive fuel connectors 154, and valve tube 154. Additional standard automotive fuel conduits 152, automotive fuel connectors 154, and valve tube 154 may differ from their counterparts (e.g., 118, 140, 124, 126, 148, and 150) in size or configuration, or both, or alternatively, may include spares duplicating the above mentioned counterparts.

In adaptor kit 200, valve tubes 106, 154 may comprise majority aluminum constituency. Also, self-closing valves 128 may each comprise a Schrader valve.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the accompanying descriptions and drawings.

I claim:

1. An adaptor for connecting a pressure gauge to a pressurized vehicular fuel conduit, the adaptor comprising
a valve tube for connection to the pressure gauge, the valve tube including a proximal end having an outwardly projecting flare and a distal end having an external thread and an internal thread;
a standard automotive fuel conduit including a distal end facing the valve tube and a proximal end;
a first standard automotive fuel connector between the valve tube and the standard automotive conduit and a second standard automotive fuel connector connected to the proximal end of the standard automotive conduit; and
a self-closing valve threaded to one of the external thread and the internal thread of the valve tube and comprising a connection thread, whereby
the adaptor may be installed on the pressurized vehicular fuel conduit using the second standard automotive fuel connector,
the pressure gauge may be threaded to the self-closing valve,
the pressure gauge, when the adaptor is installed on the pressurized vehicular fuel conduit at one end of the adaptor and to the pressure gauge at an opposed end of the adaptor, will indicate fuel pressure within the pressurized vehicular fuel conduit, and
the self-closing valve prevents external fluids from entering the pressurized vehicular fuel conduit.

2. The adaptor of claim 1, wherein the valve tube comprises majority aluminum constituency.

3. The adaptor of claim 1, wherein the self-closing valve comprises a Schrader valve.

4. An adaptor kit for connecting a pressure gauge to a pressurized vehicular fuel conduit, the adaptor comprising:
a valve tube for connection to the pressure gauge, the valve tube including a proximal end having an outwardly projecting flare, a threaded distal end, and a self-closing valve in series within the valve tube;
a first standard automotive fuel conduit having a first diameter, the first standard automotive fuel conduit including a distal end for connection to the valve tube and a proximal end for connection to the pressurized vehicular fuel conduit;
a first standard automotive fuel connector connectable by frictional engagement of the flare to the valve tube and connectable to the first standard automotive fuel conduit, and a second standard automotive fuel connector connectable to the proximal end of the first standard automotive fuel conduit and to the pressurized vehicular fuel conduit;
a second standard automotive fuel conduit having a second diameter different from the first diameter, the second standard automotive fuel conduit including a distal end for connection to the valve tube and a proximal end for connection to the pressurized vehicular fuel conduit;
a third standard automotive fuel connector connectable by frictional engagement of the flare to the valve tube, and connectable to the second standard automotive fuel conduit, and a fourth standard automotive fuel connector connectable to the proximal end of the second standard automotive fuel conduit and to the pressurized vehicular fuel conduit; and
a self-closing valve in series with the valve tube, whereby
a choice of adaptors is provided for installing on the pressurized vehicular fuel conduit to enable successful installation when a size of the pressurized vehicular fuel conduit is not known,
the pressure gauge may be threaded to the valve tube,
the pressure gauge, when the adaptor has been assembled from components of the kit and is installed on the pressurized vehicular fuel conduit at one end of the adaptor and to the pressure gauge at an opposed end of the adaptor, will indicate fuel pressure within the pressurized vehicular fuel conduit, and
the self-closing valve prevents external fluids from entering the pressurized vehicular fuel conduit.

5. The adaptor kit of claim 4, wherein the threaded distal end of the valve tube comprises both internal threads and external threads.

6. The adaptor kit of claim 4, wherein the valve tube is a first valve tube having a first diameter, and the adaptor kit further comprises a second valve tube for connection to the pressure gauge, the second valve tube having a second diameter different from the first diameter of the first valve tube, a proximal end having an outwardly projecting flare, and a distal end connectable to at least one of the first standard automotive fuel conduit and the second standard automotive fuel conduit.

7. The adaptor of claim 4, wherein the valve tube comprises majority aluminum constituency.

8. The adaptor kit of claim 4, wherein the self-closing valve comprises a Schrader valve.
